(19) United States
(12) Patent Application Publication
(10) Pub. No.: US 2007/0219857 A1
(43) Pub. Date: Sep. 20, 2007

(54) System and method for advertising and selling products and services over a decentralized network

(76) Inventors: Jonathan C. Seymour, Chicago, IL (US); Jeffrey C. Seymour, Tampa, FL (US)

Correspondence Address: BRINKS HOFER GILSON & LIONE, P.O. BOX 10395, CHICAGO, IL, 60610, US

(21) Appl. No.: 11/376,005

(22) Filed: Mar. 14, 2006

(51) Int. Cl. G06Q 30/00

(52) U.S. Cl. 705/14

(57) ABSTRACT

A system and method for advertising and selling products and services over a decentralized network is disclosed. Generally, a seller uses a stand-alone seller application to reserve keywords with a syndicated web feed provider and to send both a banner advertisement and a web-based media advertisement associated with the reserved keywords to the syndicated web feed provider. The syndicated web feed provider creates an XML file based on the reserved keywords and received advertisements, and periodically creates and disseminates a web feed comprising the XML file to a plurality of stand-alone buyer applications. In response to actions of the buyer, the stand-alone buyer application requests the banner advertisement. If a buyer clicks on a received banner advertisement, the buyer is directed to a web-based media advertisement. The buyer interacts with the web-based media advertisement and may complete a transaction for an offer of sale.

### BACKGROUND

To advertise and sell products and services on current online classified systems, sellers and potential buyers are required to expose a large amount of personal information over the Internet. For example, if a potential buyer is interested in searching the listings of an online classified system, the buyer must send a search request over the Internet to the online classified system. Due to the fact the search request may be traceable to an Internet protocol (“IP”) address sending the search request, or the search request may even be associated with a buyer account at the online classified system, it is possible for the online classified system to record the types of searches the potential buyer is requesting. Many online services may then sell accumulated profile information on potential buyers to others for different marketing purposes.

Many Internet users wish to make purchases over the Internet while still preserving their privacy. Therefore, a system is desirable that would allow potential buyers to receive classified listings, and other Internet-related advertisements, for products and services while still preserving the privacy of the potential buyer.

### BRIEF DESCRIPTION OF THE DRAWINGS

FIG. 1 is a block diagram of one embodiment of a system for advertising and selling products and services over a decentralized network;

FIG. 2 is a diagram of one embodiment of a graphical user interface for creating an offer listing;

FIG. 3 is a diagram of one embodiment of a graphical user interface for managing offer listings;

FIG. 4 is a diagram of one embodiment of a graphical user interface for announcing an offer listing;

FIG. 5 is a diagram of one embodiment of a seller device for advertising offers of sale over a decentralized network;

FIG. 6 is a flow chart of one embodiment of a method for advertising offers of sale over a decentralized network;

FIG. 7 is a diagram of one embodiment of a RSS feed provider for disseminating listings for offers of sale over a decentralized network;

FIG. 8 is a diagram of one embodiment of a method for facilitating the dissemination of offers of sale over a decentralized network;

FIG. 9 is a diagram of one embodiment of a graphical user interface for setting keywords at a buyer device;

FIG. 10 is a diagram of one embodiment of a graphical user interface for displaying partial offer listings to a buyer;

FIG. 11 is a diagram of another embodiment of a graphical user interface for displaying partial offer listings to a buyer;

FIG. 12 is a diagram of one embodiment of a graphical user interface for displaying a compete offer listing to a buyer;

FIG. 13 is a diagram of one embodiment of a graphical user interface for contacting a seller regarding an offer listing;

FIG. 14 is a diagram of another embodiment of a graphical user interface for contacting a seller regarding an offer listing;

FIG. 15 is a diagram of another embodiment of a graphical user interface for contacting a seller regarding an offer listing;

FIG. 16 is a diagram of one embodiment of a buyer device for receiving offers of sale over a decentralized network;

FIG. 17 is a flow chart of one embodiment of a method for receiving offers of sale over a decentralized network;

FIG. 18 is a block diagram of another embodiment of a system for advertising offers of sale over a decentralized network;

FIG. 19 is a diagram of one embodiment of a graphical user interface for displaying a banner advertisement as a user device;

FIG. 20 is a diagram of one embodiment of a graphical user interface for displaying a web-based media advertisement associated with the banner advertisement of FIG. 19 within a buyer application;

FIG. 21 is a diagram of one embodiment of a graphical user interface for displaying a web-based media advertisement associated with the banner advertisement of FIG. 19 in an application other than a buyer application;

FIG. 22 is a block diagram of another embodiment of a seller device for advertising offers of sale over a decentralized network;

FIG. 23 is a flow chart of another embodiment of a method for advertising offers of sale over a decentralized network;

FIG. 24 is a block diagram of another embodiment of a RSS feed provider for disseminating listings of offers of sale over a decentralized network;

FIG. 25 is a flow chart of another embodiment of a method for disseminating listings of offers of sale over a decentralized network;

FIG. 26 is a block diagram of another embodiment of a buyer device for receiving offers of sale over a decentralized network;

FIG. 27 is a flow chart of another embodiment of a method for receiving offers of sale over a decentralized network; and

FIG. 28 is a block diagram of another embodiment of a system for advertising offers of sale over a decentralized network.

### DETAILED DESCRIPTION OF THE DRAWINGS

The present disclosure is directed to a system and method for advertising and selling products and services over a decentralized network. The disclosed system provides increased security to both buyers and sellers through the use of stand-alone applications that only reside on user devices so that only information a buyer or seller specifically publishes to the system is disseminated over the network. Further, due to the fact offer listings and advertisements are displayed in response to specific actions and requests of the buyer, the disclosed system provides sellers with targeted advertising in that an offer listing or advertisement of the seller is only displayed to a buyer that has expressed an interest in purchasing the product or service. Similarly, because offer listings and advertisements are displayed in response to specific actions and requests of the buyer, the disclosed system provides buyers more relevant listings related to products and service that the buyer is actually interested in purchasing.

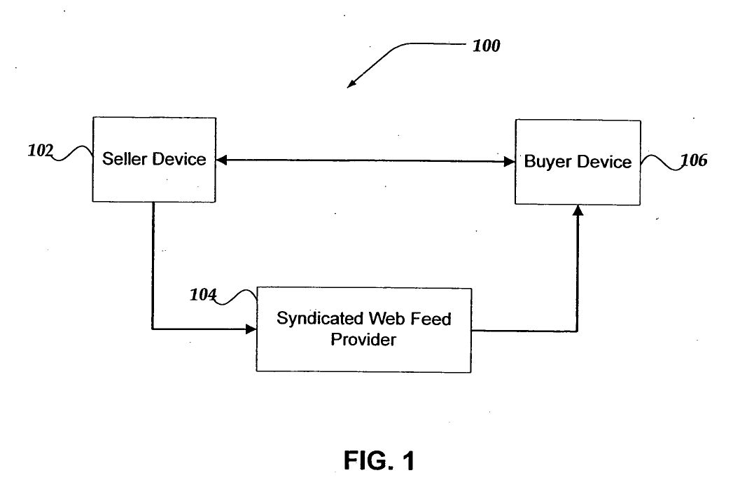

FIG. 1 is a block diagram of one embodiment of a system for advertising and selling products and services over a decentralized network. The system 100 comprises a seller device 102, a syndicated web feed provider 104, such as a really simple syndication, or rich site summary, (“RSS”) feed provider, and a buyer device 106. The seller and buyer devices 102, 106 may be a personal computer, server, personal digital assistant (“PDA”), cellular phone, or any other type of computing device known in the art. The syndicated web feed provider 104 may be a personal computer, a server, or any other type of computing device known in the art.

Generally, a seller uses a stand-alone seller application residing only on the seller device 102 to generate an offer listing (an offer of sale) that may comprise information such as a headline providing a short text message or graphical representation summarizing an offer of sale, a category for the offer of sale, a description of the offer of sale, one or more images associated with the offer of sale, and a price associated with the offer of sale. In one embodiment, the offer listing is saved on the seller device 102 as an HTML file.

After the offer listing is created, the seller application extracts at least the headline from the offer listing and sends at least the headline to the syndicated web feed provider 104. It will be appreciated that while the exemplary embodiments described below are directed to a syndicated web feed provider 104 that is a RSS feed provider 104, the syndicated web feed provider 104 may provide data in formats such as Rich Site Summary (RSS 0.91), RDF Site Summary (RSS 0.9 and 1.0), Really Simple Syndication (RSS 2.0), any other extensible markup language (“XML”) standard used for standardized transmission of information over the Internet, or any other communication standard for encoding data and delivering the encoded data in a contextually relevant manner to one or more buyer devices 106 as explained in detail below. The RSS feed provider 104 accepts the headline, creates a RSS file based on the received headline, and clears the received headline from the RSS feed provider 104. Periodically, the RSS feed provider 104 disseminates a RSS feed comprising the RSS files of headline information to the buyer devices 106 of potential buyers.

Potential buyers use a stand-alone buyer application residing only on the buyer devices 106 to receive the RSS feed from the RSS feed provider 104. Typically, the potential buyer will have configured their buyer application with a plurality of keywords or phrases that indicate various products or services the buyer is interested in purchasing or receiving advertising about. When the buyer application receives the RSS feed, the buyer application parses the RSS feed for products or services that the buyer may be interested in. To parse the RSS feed, the buyer application may utilize text matching to match the keywords or phrases that indicate products or services the buyer is interested in purchasing with terms in the RSS feed such as terms in the headlines of the offer listings, or the buyer application may utilize various natural language algorithms.

After parsing the RSS feed, headlines for products or services that the potential buyer may be interested in appear in the buyer application running on the buyer device 106 and may be sorted by the buyer according to various parameters such as a product or service category, price, date the headline was received, etc. When a buyer would like to inquire about an offer of sale, the buyer contacts the seller by using the buyer application running on the buyer device 106 to directly contact the seller application running on the seller device 102 without using the RSS feed provider 10 or another third-party communication provider. The buyer and seller may communicate over instant messaging, email, or any other communication medium regarding the product or service. Typically, the buyer will request the offer listing originally created by the seller comprising information such as a short headline to describe the product or service, a category for the product or service, a product or service description, images of the product or service, and a price of the product or service. The seller sends the offer listing, typically as an HTML file, directly from the seller device 102 to the buyer device 106, and the transaction is either completed after negotiations or the transaction is abandoned.

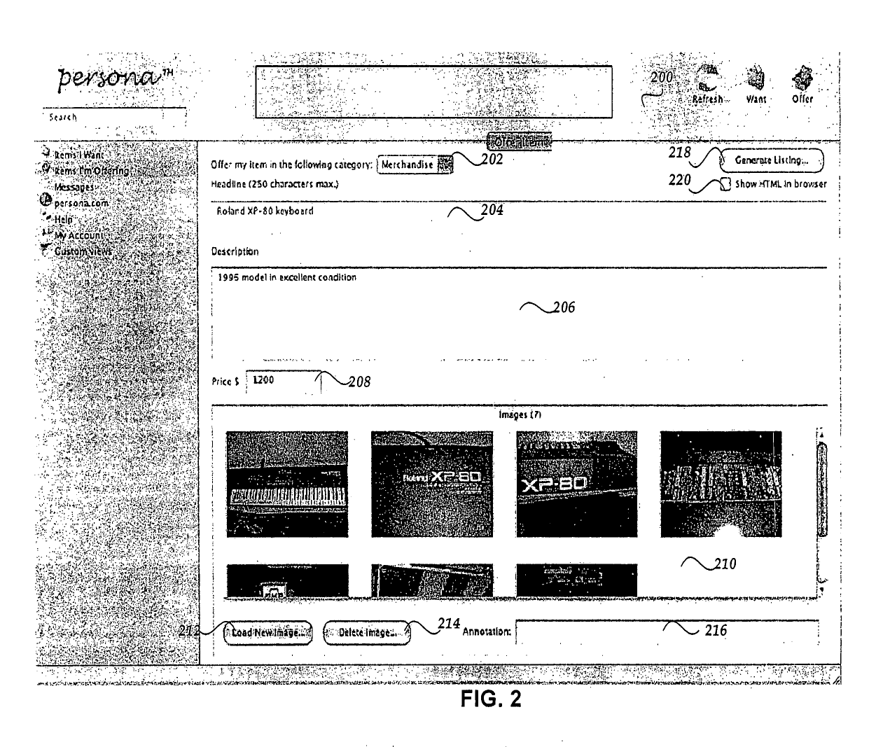

FIG. 2 is a diagram of one embodiment of a graphical user interface (“GUI”) 200 of a stand-alone seller application running on a seller device 102 (FIG. 1) for creating an offer listing. Typically, the seller application running on the seller device is located on the seller device only. To increase the privacy of a seller, no portion of the stand-alone seller application is hosted on a device other than the seller device so that no information related to the seller is exposed to the Internet, or any other type of network, except information the seller intentionally publishes.

To create the offer listing, a seller interacts with the offer creation GUI 200 to select a category for an offer of sale from a category drop-down menu 202; enter a headline to briefly describe the offer of sale in a headline field 204; enter a detailed description to more fully describe the offer of sale in a description field 206; enter a price associated with the offer of sale in a price field 208; insert one or more pictures associated with the offer of sale in an image window 210 using an insert image hyperlink 212 or a delete image hyperlink 214; and insert an annotation associated with the offer listing in an annotation field 216.

The category drop-down menu 202 allows the seller to select a category associated with the offer listing. Typically, a seller may create an offer listing for physical products such as musical instruments or computer hardware; services such as those offered by a physician or an attorney; events such as concerts; real estate listings; travel packages; or any other product or service a seller may desire to offer for sale. A user may also create offer listings relating to general areas of sale or interest that another user may desire to receive information regarding, rather than a specific offer to sell a particular product or service. For example, a user may create an offer listing relating to activities, leisure, media, computers, music, or any other general area of interest a user may desire to create an offer listing regarding. Therefore, the category drop-down menu 202 may comprise categories such as merchandise in general, services in general, a specific type of merchandise, a specific type of service, travel, events, real estate, activities & leisure, information & media, or any other pre-defined category desired by a seller, buyer, or RSS feed provider.

The headline field 204 allows the seller to insert a short description of the offer of sale being offered in the offer listing. As described above, it is typically the short description in the headline field 204 that will be sent to the RSS feed provider and disseminated to potential buyers. In one embodiment, the short description in the headline field 204 may be limited to a number of ASCII characters such as 250 characters.

The description field 206 allows a seller to insert a detailed description of the offer of sale being offered in the offer listing. Typically, the description field 206 does not comprise a ASCII character limitation such as in the headline field 204 so that a seller may provide an expanded description of the offer of sale. As described above, when a potential buyer contacts a seller, the potential buyer may request the complete offer listing to obtain more detailed information on the offer of sale such as that in the description field 206.

The price field 208 allows a seller to insert the price associated with the offer of sale. Typically, the seller application extracts the price in the price field 208 along with the short description in the headline field 204 to be disseminated to potential buyers.

The image window 210 displays one or more images that a seller has associated with an offer listing. Typically, the seller may actuate the insert image hyper link 212 to add an image to the offer listing. In response to actuating the insert image, a secondary GUI is created allowing the seller to choose an image saved on the seller device. Further, the seller may typically delete an image displayed in the image window 210 by selecting an image and actuating the delete image hyperlink 214. The annotation field 216 allows a seller to insert comments associated with any image that the seller associated with the offer listing.

After a seller has interacted with the offer creation GUI 200 to create an offer listing, the seller may actuate a generate listing hyperlink 218 to create and store an offer listing file storing the information in the category drop-down menu 202, the headline field 204, the description field 206, the price field 208, the image window 210, and the annotation field 216. In one embodiment the offer listing file is saved as a Hypertext Markup Language (“HTML”) file, but any file format could be used. Additionally, when creating the offer listing file, the seller may select a preview box 220 to preview the offer listing in an application such as an Internet browser when the seller creates the offer listing.

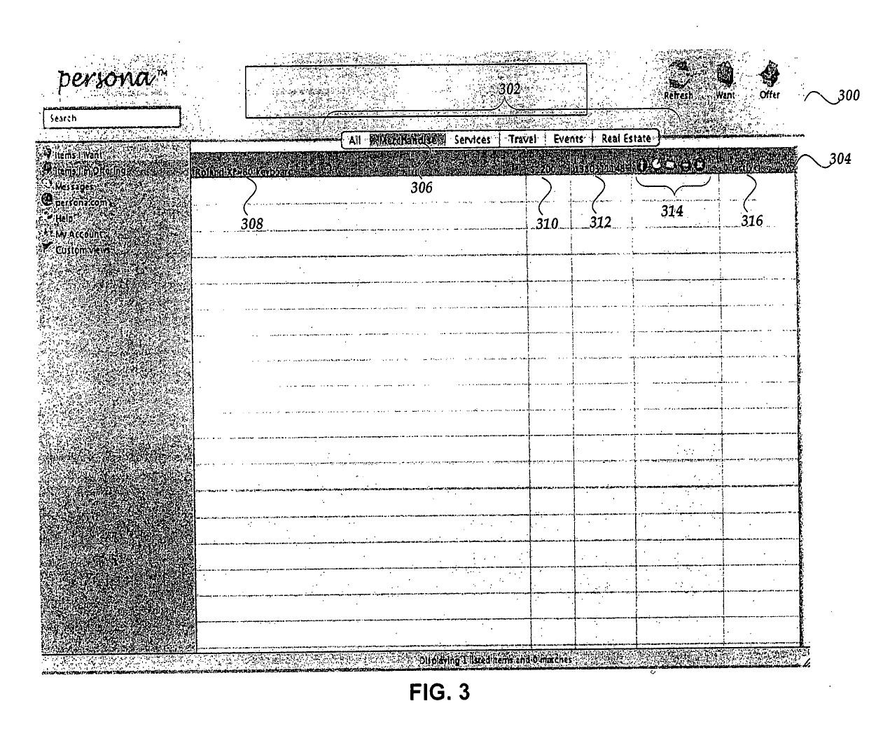

After a seller creates an offer listing, the seller may interact with the seller application to perform one or more functions regarding the offer listing. FIG. 3 is a diagram of one embodiment of a graphical user interface (“GUI”) of a stand-alone seller application running on a seller device 102 (FIG. 1) for managing offer listings. Generally, the management GUI 300 comprises one or more offer categories 302 and one or more offer listing summaries 304 associated with a selected category 306. It will be appreciated that the one or more offer categories 302 are typically the same categories as those available to a seller in the category drop-down menu 202 (FIG. 2) of the offer creation GUI 200 (FIG. 2). In one embodiment, the categories 302 may comprise an All hyperlink, a Merchandise hyperlink, a Services hyperlink, a Travel hyperlink, an Events hyperlink, and a Real Estate hyperlink.

When the seller actuates the All hyperlink, the seller application displays summaries of all offer listings created by the seller. When the seller actuates the Merchandise hyperlink, Services hyperlink, Travel hyperlink, Events hyperlink, or Real Estate hyperlink, the seller application only displays summaries of the offer listings associated with the actuated category. In FIG. 3, the seller has selected 306 the Merchandise hyperlink. Accordingly, the seller application is displaying the one or more offer listing summaries 304 associated with the Merchandise category.

In one embodiment, each listing summary 304 comprises the headline of the offer listing 308, a price associated with the offer of sale of the offer listing 310, a unique identifier associated with the offer listing 312, one or more action icons 314, and a number of messages received relating to an offer listing 316. The one or more action icons 314 allow the seller to quickly perform actions on the offer listing. For example, in response to actuating a first icon, the seller application may display a short summary of information about the offer listing; in response to actuating a second icon, the seller application may launch a graphical user interface for editing the offer listing; in response to actuating a third icon, the seller application may launch a graphical user interface for scheduling events associated with the offer listing such as a scheduled discussion regarding the offer listing with a potential buyer; in response to actuating a fourth icon, the seller application may activate, pause, or stop an offer listing; or in response to actuating a fifth icon, the seller application may delete an icon.

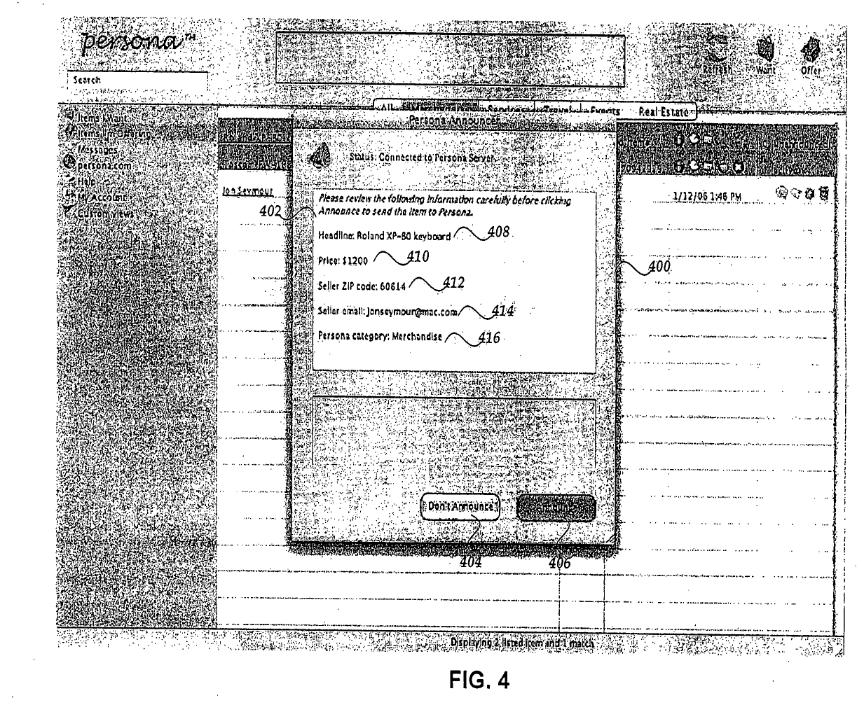

When the seller selects an offer listing summary 304 and actuates a predetermined icon of the one or more action icons 314, the seller application launches a secondary GUI for announcing the offer listing to the RSS feed provider. FIG. 4 is a diagram of one embodiment of a graphical user interface (“GUI”) 400 of a stand-alone seller application running on the seller device 102 (FIG. 1) for announcing an offer listing. Typically the announcement GUI 400 comprises a preview window 402, a cancel hyperlink 404, and an announce hyperlink 406.

The preview window 402 provides the seller with a preview of the offer listing the seller is about to announce. In one embodiment, the preview window 402 may comprise the headline of the offer listing 408, the price associated with the offer of sale 410, a zip code of the seller offering the offer of sale 412, an email address of the seller 414, and a category of the offer listing 416. Typically, the seller application extracts the headline of the offer listing 408, price associated with the offer of sale 410, and category of the offer listing 416 from the offer listing and the seller application extracts the zip code of the seller 412 and the email address of the seller 414 from an account profile of the seller saved on the seller device.

If the seller reviews the information in the preview window 402 and actuates the cancel hyperlink 404, the announcement GUI 400 closes and the selected offer listing is not announced to the RSS feed provider. However, if the seller reviews the information in the preview window 402 and actuates the announce hyperlink 406, the seller application sends the information shown in the preview window 402 to the RSS feed provider. The seller may send the information to the RSS feed provider using a broadband internet connection, dial-up internet connection, or any other type of internet connection known in the art.

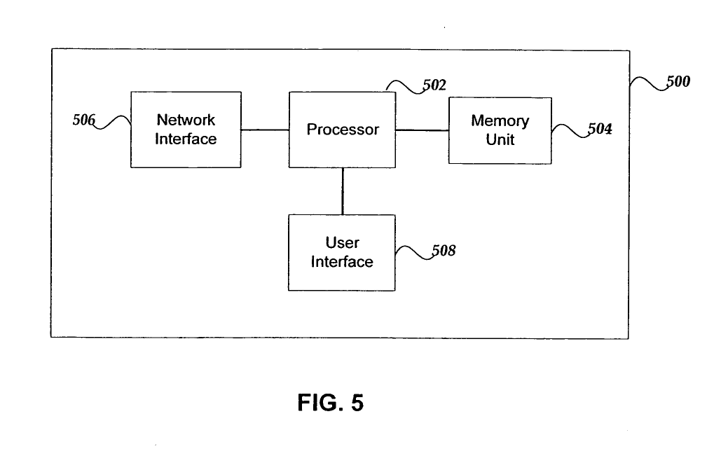

FIG. 5 is a block diagram of one embodiment of a user device for advertising offers of sale over a decentralized network. Typically, the user device 500 comprises a processor 502, a memory 504 in communication with the processor 502, a network interface 506 in communication with the processor 502, and a user interface 508 in communication with the processor 502. During operation, the processor 502 is operative to execute instructions stored in memory 504 to receive commands from a seller via the user interface 508 for creating an offer listing. In one embodiment, the processor 502 executes instructions to create graphical user interfaces such as those described above with respect to FIGS. 2-4.

After receiving the commands from the seller, the processor 502 executes further instructions stored in memory 504 to create the offer listing based on the received commands and to extract a set of information from the offer listing and an account profile. In one embodiment, the buyer application extracts a headline, price, and category from the offer listing, but any data stored in the offer listing could be extracted. The processor 502 executes further instructions stored in memory 504 to send the extracted set of information via the network interface 506 to a RSS feed provider.

In one embodiment, the processor 502 may execute further instructions stored in memory 504 to receive an inquiry via the network interface 506 directly from a potential buyer, to facilitate direct negotiations with the potential buyer via the network interface 506 regarding a price for the offer of sale of the offer listing, and to abandon or complete the transaction based on the negotiations.

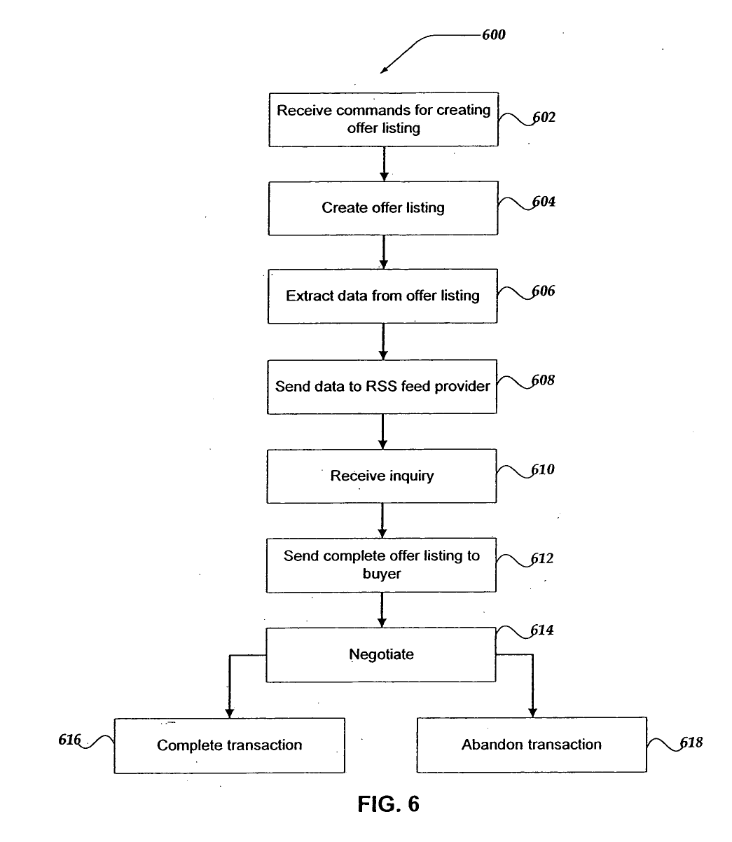

FIG. 6 is a flow chart of one embodiment of a method for advertising offer of sale over a decentralized network. The method 600 begins with a stand-alone seller application running on a seller device receiving commands from a user for creating an offer listing for an offer of sale 602. The seller application creates the offer listing based on the received commands 604 and extracts a set of data from the offer listing and an account profile 606. In one embodiment, the seller application extracts a headline, price, and category from the offer listing, and a zip code and email address of the seller from the account profile. The seller application then sends at least the extracted set of data to a RSS feed provider 608.

After the RSS feed provider disseminates the partial offer listings to potential buyers, the seller application may receive an inquiry directly from a potential buyer regarding the partial offer listing 610. Typically, the potential buyer requests the complete offer listing and the seller sends the complete offer listing directly to the potential buyer 612. The seller may negotiate directly with the potential buyer 614 and complete the transaction 616 or abandon the transaction 618 based on the negotiations. In one embodiment, the negotiations between the seller and potential buyer 614 may utilize a direct email exchange or instant messaging without exposing information to the RSS feed provider.

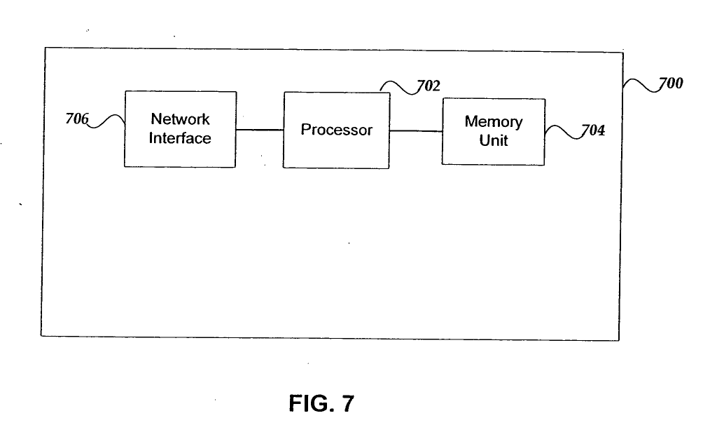

FIG. 7 is a diagram of one embodiment of a RSS feed provider for disseminating offer listings to one or more potential buyers. Typically, the RSS feed provider 700 comprises a processor 702, a memory 704 in communication with the processor 702, and a network interface 706 in communication with the processor 702. During operation, the processor 702 is operative to execute instructions stored in memory 704 to receive a set of data from a seller device via the network interface 706 describing an offer of sale. The processor 702 executes additional instructions stored in memory 704 to create a RSS file based on the received set of data and to clear the received set of data from the RSS feed provider 700.

Periodically, the processor 702 executes instructions stored in memory 704 to create a RSS feed comprising the RSS file based on the received set of data and to disseminate the RSS feed to a plurality of buyer devices 106 (FIG. 1) via the network interface 706.

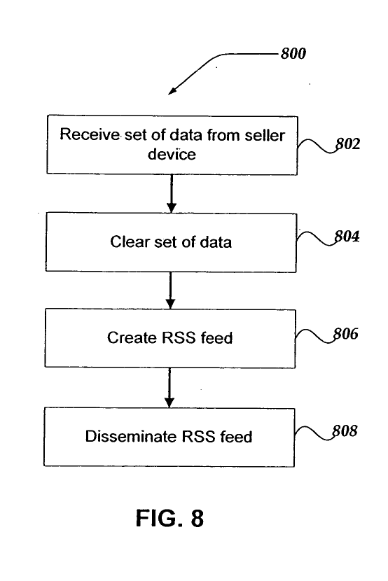

FIG. 8 is a diagram of one embodiment of a method for disseminating offers of sale over a decentralized network. The method 800 begins with a RSS feed provider receiving a set of data from a seller device 802. In one embodiment, the set of data may comprise a headline, price, and category of an offer listing. The RSS feed provider creates a RSS file based on the received set of data and clears the received set of data from the RSS feed provider 804. Periodically, the RSS feed provider creates a RSS feed comprising the RSS file based on the received set of data 806 and disseminates the RSS feed to a plurality of buyer devices 808.

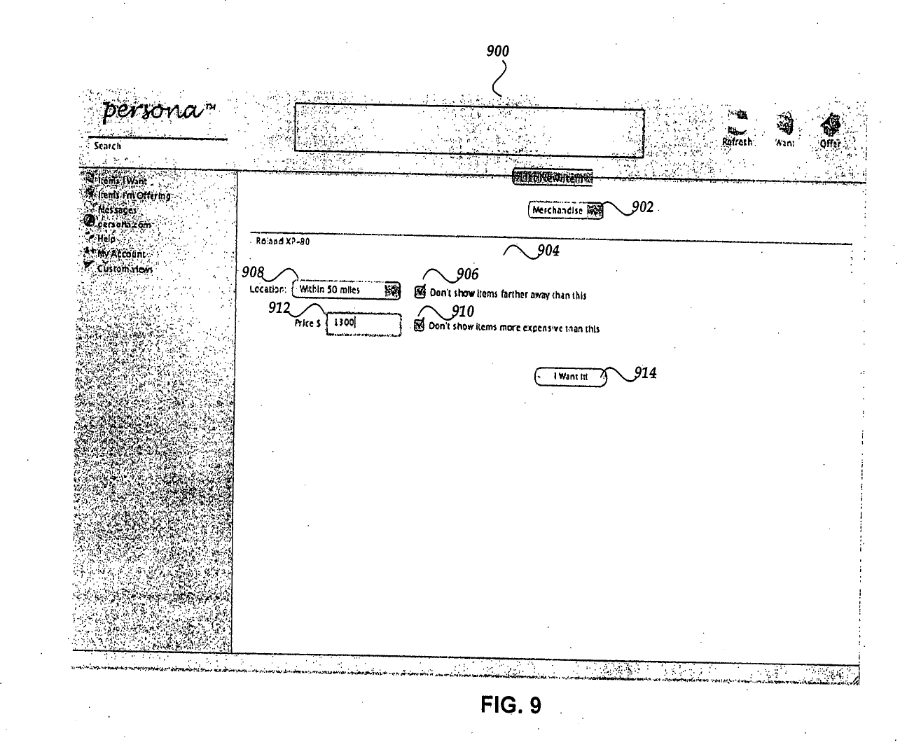

As described above, when a buyer device receives the RSS feed from the RSS feed provider, the buyer application parses the RSS feed into one or more partial offer listings and matches at least one of the one or more offer listings with a keyword saved at the buyer device. FIG. 9 is a diagram of one embodiment of a graphical user interface (“GUI”) 900 for a stand-alone buyer application running on a buyer device 106 (FIG. 1) for setting keywords. Typically, the buyer application running on the buyer device is located on the buyer device only. To increase the privacy of the buyer, no portion of the stand-alone buyer application is hosted on a device other than the buyer device so that no information related to the buyer is exposed to the Internet, or any other type of network, except information the buyer intentionally publishes.

To set a keyword at the buyer application, the buyer interacts with the keyword GUI 900 to select a category for a desired offer of sale from a category drop-down menu 902; enter a keyword or phrase for a desired offer of sale in a keyword field 904; activate a distance filter for offer listing results associated with the keyword in the keyword field 904 by choosing whether to turn on the distance filter 906 and choosing a geographic boundary from a distance drop-down menu 908; and activate a price filter for offer listings associated with the keyword in the keyword field 904 by choosing whether to turn on the price filter 910 and entering a price threshold in a price threshold field 912.

The category drop-down menu 902 allows the buyer to select a category associated with a keyword. It will be appreciated that typically, the categories in the category drop-down menu 902 of the keyword GUI 900 correspond to the categories in the category drop-down menu 202 (FIG. 2) of the offer creation GUI 200 (FIG. 2) so that the buyer may select a category relating to areas such as products, service, or general areas of sale or interest. Due to this correlation, the buyer will only be able to create keywords for categories in which sellers will be able to create offer listings.

The keyword field 904 allows a buyer to insert single keywords or keyword phrases corresponding to offers of sale that the buyer is willing to receive offer listings or advertisements about. It is these keywords that the buyer application uses for text matching or natural language algorithm matching when a RSS feed is received from the RSS feed provider. The distance filter allows a buyer to create a filter that filters out offer listing that are received from a seller located more than a predefined distance from the buyer. To create the filter, the buyer selects the box 906 associated with the distance filter and selects a geographic boundary from the distance drop-down menu 908. The price filter allows a buyer to create a filter that filters out offer listings that are received having a price more than a predetermined threshold. To create the filter, the buyer selects the box 910 associated with the price filter and enters a price in the price threshold field 912.

After the buyer has interacted with the keyword GUI 900 to enter a keyword and create any filters associated with the keyword, the buyer may actuate a save hyperlink 914 that saves the keyword at the buyer device. After the buyer application parses a received RSS feed, the buyer application searches the one or more partial offer listings for any matches with the keywords created using the keyword GUI 900. To search for a match between the keywords and the partial offer listings, the buyer application may implement text matching, natural language algorithms, or any other matching algorithm known in the art.

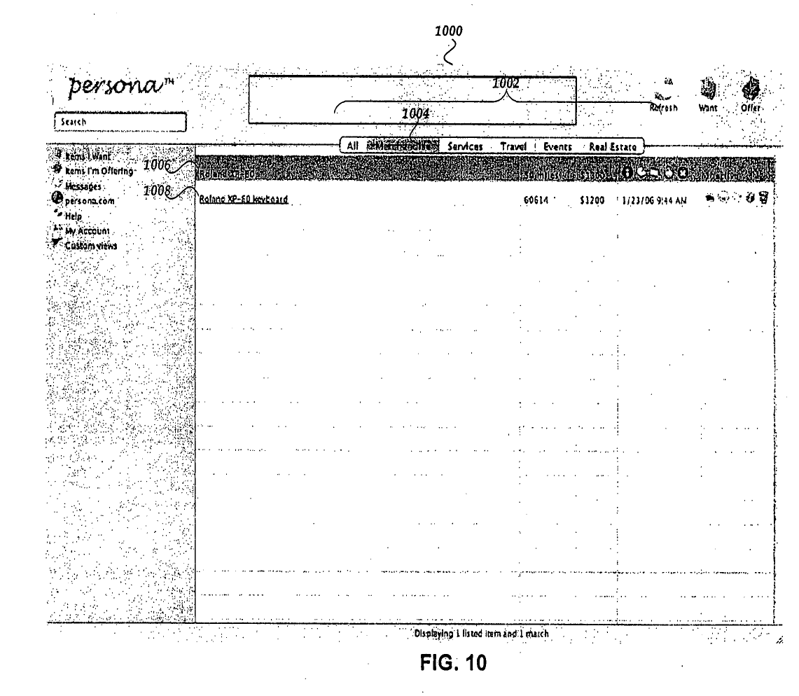

Any partial offer listings that are matched with a keyword saved at the buyer device and meet the filter criteria associated with the keyword are displayed to the buyer. FIG. 10 is a diagram of one embodiment of a graphical user interface (“GUI”) 1000 for a stand-alone buyer application running on a buyer device 106 (FIG. 1) for displaying partial offer listings to a buyer. Generally, the display GUI 1000 comprises one or more category hyperlinks 1002. It will be appreciated that the categories of the category hyperlinks 1002 typically correspond to the categories available to a seller when creating an offer listing and the buyer when setting a keyword.

When a buyer selects a category 1004, the buyer application displays one or more keyword headings 1006 associated with the selected category 1004. The keyword headings 1006 typically comprise a listing of the keyword, a geographic boundary of a distance filter associated with the keyword, a price threshold of a price filter associated with the keyword, one or more action icons associated with the keyword, and a number of received partial offer listings that match the keyword.

Generally, the one or more action icons provide the user the ability to quickly manage the partial offer listings associated with a keyword. For example, in response to actuating a first icon, the buyer application may display a short summary of information about the keyword; in response to actuating a second icon, the buyer application may launch a graphical user interface for editing a keyword and any filters associated with the keyword; in response to actuating a third icon, the buyer application may launch a graphical user interface for scheduling events associated with the keywords; in response to actuating a fourth icon, the buyer application may activate, pause, or stop the buyer application from matching offer listings associated with the keyword; or in response to actuating a fifth icon, the buyer application may delete the keyword.

Below each keyword heading 1006, the buyer application displays one or more partial offer listings 1008 matching the keyword of the keyword heading 1006. Typically, each partial offer listing 1008 comprises a headline of the offer listing, a location of the seller offering the product or service, a price associated with the offer listing, a date when the buyer application receives the partial offer listing, and one or more action icons associated with the partial offer listing.

Generally, the one or more action icons associated with the partial offer listing provide a buyer the ability to quickly manage a partial offer listing. For example, a first icon, may notify a potential buyer that a partial offer listing is new; in response to actuating a second icon, the buyer application may launch a graphical user interface for sending an instant message to a seller who created the partial offer listing; in response to actuating a third icon, the buyer application may launch a graphical user interface for sending an email to a seller who created the partial offer listing; in response to actuating a fourth icon, the buyer application may launch a graphical user interface for scheduling events associated with the partial offer listing; or in response to actuating a fourth icon, the buyer application may delete the partial offer listing.

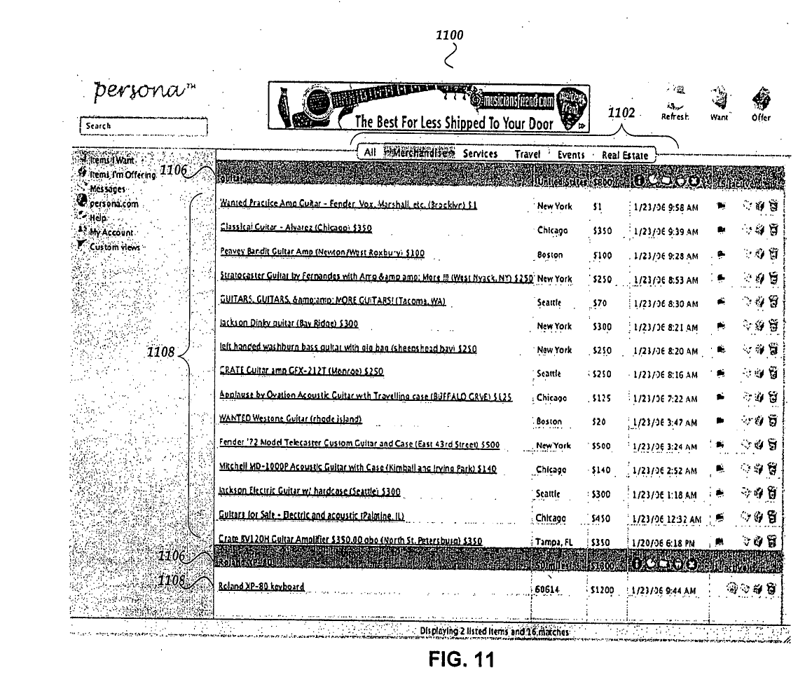

FIG. 11 is a diagram of another embodiment of a graphical user interface (“GUI”) for a stand-alone buyer application running on a buyer device for displaying partial offer listings to a buyer. It will be appreciate that like the display GUI 1000 of FIG. 10, the display GUI 1100 of FIG. 11 comprises one or more category hyperlinks 1102, one or more keyword headings 1106, and one or more partial offer listings 1108 associated with a keyword. FIG. 11 illustrates how the display GUI 1100 would appear with multiple keyword headings 1106 and multiple offer listings 1108 associated with each keyword heading 1106.

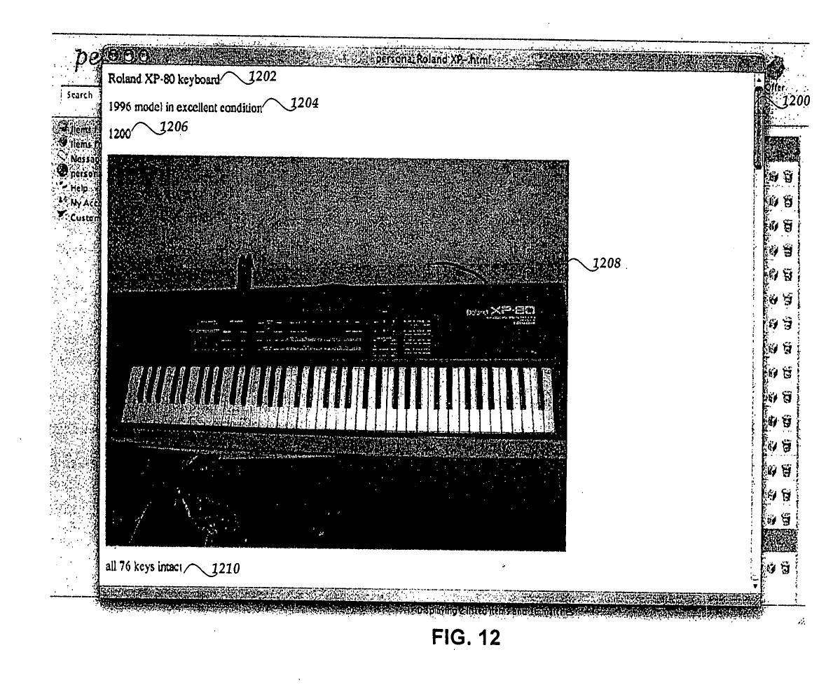

When a buyer is interested in an offer of sale, the buyer may use the buyer application to directly contact the seller application and request the complete offer listing. FIG. 12 is a diagram of one embodiment of a graphical user interface (“GUI”) 1200 for a stand-alone buyer application running on a buyer device 106 (FIG. 1) for displaying a compete offer listing to a buyer. After the complete offer listing is received from the seller, the buyer application may display the complete offer listing comprising a headline of the offer listing 1202, a description of the offer of sale 1204, a price associated with the offer of sale 1206, any images associated with the offer of sale 1208, and any annotations associated with the offer listing 1210.

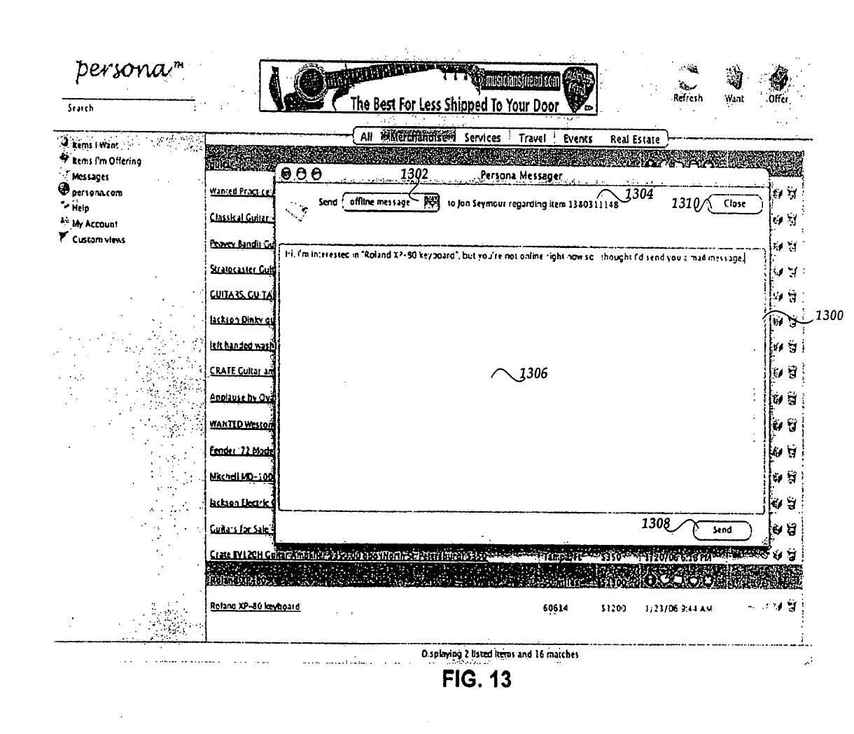

If a buyer is interested in purchasing the product or service of the offer listing, the buyer uses the buyer application to directly contact the seller via the seller application. Typically, the buyer may contact the seller over instant messaging, email, or any other communication medium. FIGS. 13-15 are diagrams of different embodiments of graphical user interfaces (“GUIs”) for direct communications between the seller and buyer. Generally, the message GUI 1300, 1400, 1500 comprises a message-type drop-down menu 1302, 1402, 1502, an offer listing header 1304, 1404, 1504, and a message field 1306, 1406, 1506.

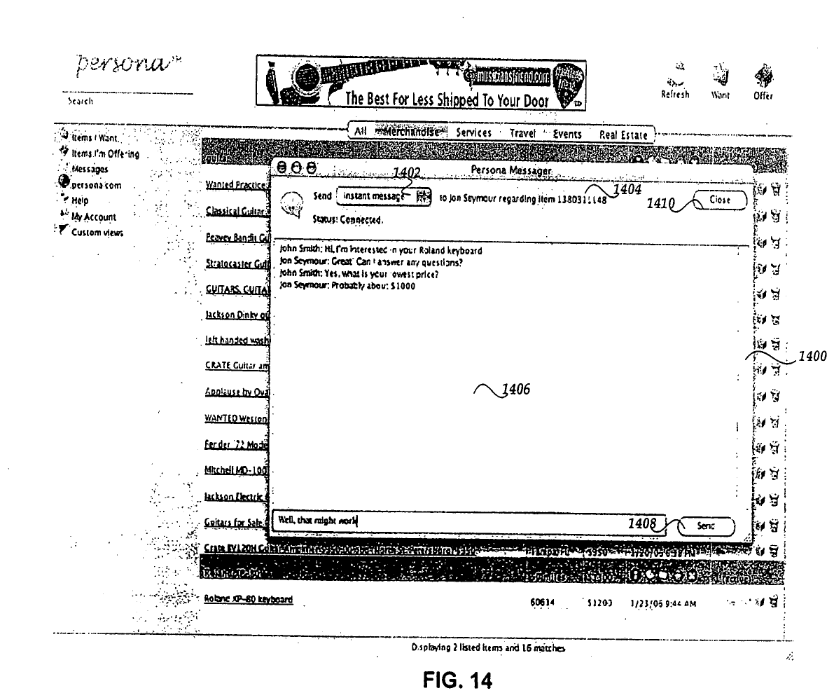

The message-type drop-down menu 1302, 1402, 1502 provides a buyer or seller the ability to choose a type of message to send. For example, as shown in FIG. 13, a buyer may choose to send an email to the seller when the seller is not online and, as shown in FIG. 14, the buyer may choose to send an instant message to the seller when the seller is online. The listing header 1304, 1404, 1504 provides a buyer and seller a quick reference to the offer listing the communication is regarding. Finally, the message field 1306, 1406, 1506 is where the buyer or seller actually creates a message.

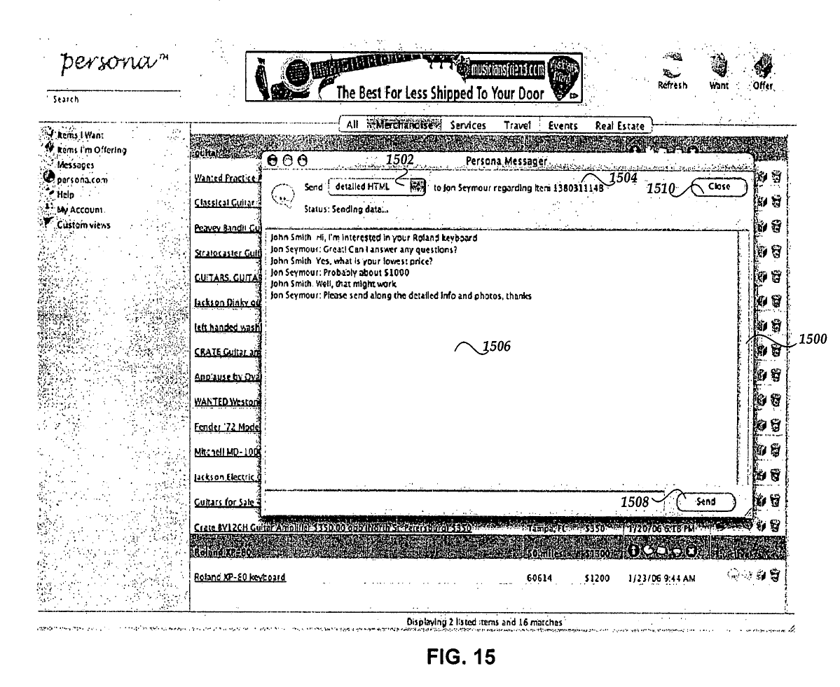

After creating the message, the buyer may actuate a send hyperlink 1308, 1408, 1508 to send the message to the seller. However if at any time the seller decides not to send the message to the seller, the seller may actuate the close hyperlink 1310, 1410, 1510 to close the message GUI 1300, 1400, 1500. It will be appreciated that the message GUI 1500 of FIG. 15 also provides a seller the ability to send the complete offer listing to the buyer.

Typically, the seller and buyer will negotiate the transaction through direct communication and complete or abandon the transaction depending on the negotiations.

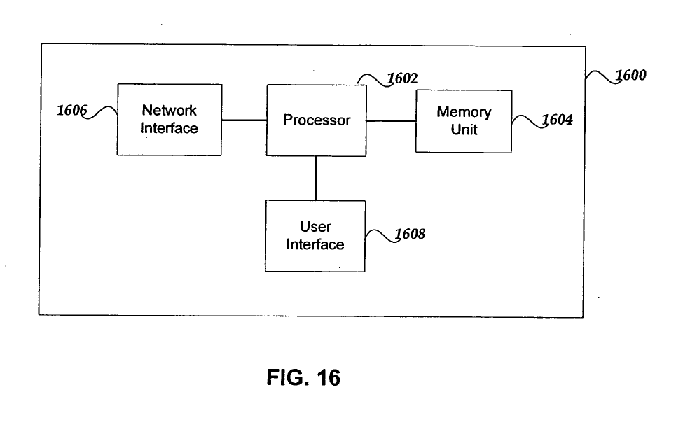

FIG. 16 is a diagram of one embodiment of a buyer device or purchasing products and services over a decentralized network. Typically, the buyer device 1600 comprises a processor 1602, a memory 1604 in communication with the processor 1602, a network interface 1606 in communication with the processor 1602, and a user interface 1608 in communication with the processor 1602. During operation, the processor 1602 is operative to execute instructions stored in memory 1604 to receive commands from a buyer to save keywords in memory 1604. In one embodiment, the processor 1602 executes instructions to create graphical user interfaces such as those described above with respect to FIGS. 9-14.

The processor 1602 continues to execute instructions stored in memory 1604 to receive a RSS feed from a RSS feed provider via the network interface 1606 and parse the RSS feed into one or more partial offer listings. After parsing the RSS feed into one or more partial offer listings, the processor 1602 executes instructions stored in memory 1604 to match one or more of the partial offer listings to a keyword stored in memory 1604 using text matching, natural language algorithms, or any other matching algorithm. The processor 1602 executes instructions stored in memory to filter the partial offer listings that match a keyword based on any filters created by the buyer with respect to the keyword, and to display the filtered partial offer listings to the buyer via the user interface 1608.

After displaying the filtered partial offer listings, the processor 1602 executes instructions stored in memory 1604 to receive commands from the buyer via the user interface 1608 to send an inquiry to a seller and to send an inquiry to the seller via the network interface 1606 based on the received commands. The processor 1602 executes additional instructions stored in memory 1604 to receive a complete offer listing via the network interface 1606 from the seller and to display the complete offer listing to the buyer via the user interface 1608.

The processor 1602 may then execute additional instructions stored in memory 1604 to receive commands from the buyer via the user interface 1608 for negotiating directly with the seller, to facilitate direct negotiations via the network interface 1608 with the seller based on the received commands, and to complete or abandon the transaction based on the received commands. The negotiations may comprise communications over email, instant messaging, or any other communication medium.

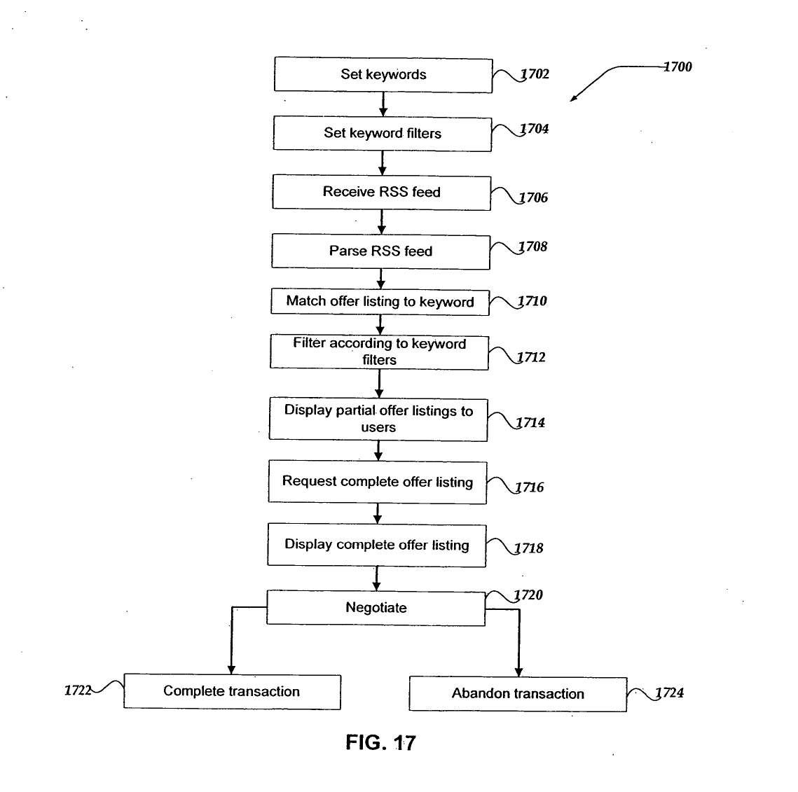

FIG. 17 is a flow chart of one embodiment of a method for receiving offers of sale over a decentralized network. The method 700 begins with a buyer setting keywords 1702 and any filters associated with the keywords 1704 at a stand-alone buyer application running on a buyer device. The buyer device receives a RSS feed from a RSS feed provider 1706 and the buyer application parses the RSS feed into one or more partial offer listings 1708.

The buyer application matches at least one of the one or more partial offer listings to the keywords of the buyer 1710 using text matching, natural language algorithms, or any other type of matching algorithm. The partial offer listings that match the keywords are filtered according to any filters associated with the keyword 1712 and the filtered partial offer listings are displayed to the buyer 1714.

After viewing the filtered partial offer listings, the buyer may send a request directly to the seller for a complete offer listing 1716. The buyer receives the complete offer listing 1718 and directly negotiates 1720 a price for the offer of sale with the seller over email, instant messaging, or any other communication medium. Finally, the transaction is completed 1722 based on the negotiations between the buyer and seller, or the transaction is abandoned 1724.

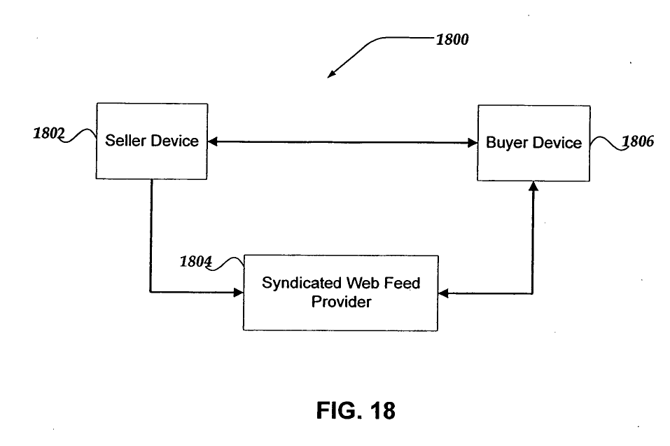

In addition to offer listings described above, the disclosed system provides for sending advertisements such as banner advertisements to a potential buyer which may direct the potential buyer to video clips or other web-based media regarding offers of sale. FIG. 18 is a block diagram of one embodiment of a system for disseminating offers of sale over a decentralized network. The system comprises a user device 1802, a syndicated web feed provider 1804 such as a RSS feed provider, and a buyer device 1804. It will be appreciated that in one embodiment, the user device 1802, RSS feed provider 1804, and buyer device 1806 may be the same user device 102, RSS feed provider 104, and buyer device as described above with respect to FIGS. 1-17.

Generally, to advertise an offer of sale over a decentralized network, a seller uses a stand-alone seller application running on a seller device 1802, or other direct communication with an operator(s) of the RSS feed provider 1804, to reserve keywords with the RSS feed provider 1804 and to send both a banner advertisement and a web-based media advertisement associated with the reserved keywords to the RSS feed provider 1804. It will be appreciated that in one embodiment, the stand-alone seller application may be the same stand-alone seller application described above with respect to FIGS. 1-17, or the stand-alone seller application may be a different stand-alone application.

In addition to the banner advertisement, the web-based media advertisement the seller device 1802 sends to the RSS feed provider 1804 may be a multimedia presentation, an Internet address, or any other type of Internet-related media known in the art. The RSS feed provider 1804 receives the reserved keywords, banner advertisement, and web-based media advertisement associated with the reserved keywords and creates a RSS file, which may reside at the RSS feed provider 1804 as long as a seller has reserved keywords with the RSS feed provider 1804. Periodically, the RSS feed provider 1804 creates a RSS feed comprising the RSS file based on the reserved keywords and advertisements associated with the reserved keywords. In one embodiment, the RSS feed may be the same RSS feed described above with respect to FIGS. 1-17 comprising partial offer listings.

The buyer device 1806 receives the RSS feed from the RSS feed provider 1804 and a stand-alone buyer application parses the RSS feed into one or more partial offer listings that the buyer may be interested in and one or more locations of banner advertisements related to offers of sale that the buyer may be interested in. It will be appreciated that in one embodiment, the stand-alone buyer application may be the same stand-alone buyer application described above with respect to FIG. 1-17, or the stand-alone buyer application may be a different stand-alone application.

When a buyer performs actions in the buyer application such as clicking to see offer listings related to a keyword, the buyer application automatically requests a banner advertisement from the RSS feed provider 1804 relating to the selected keyword based on the one or more locations of banner advertisements parsed from the RSS feed. The RSS feed provider 1804 sends the banner advertisement along with a location at the RSS feed provider 1804 for the web-based media advertisement associated with the banner advertisement to the buyer device 1806 and the buyer application displays the received banner advertisement to the buyer.

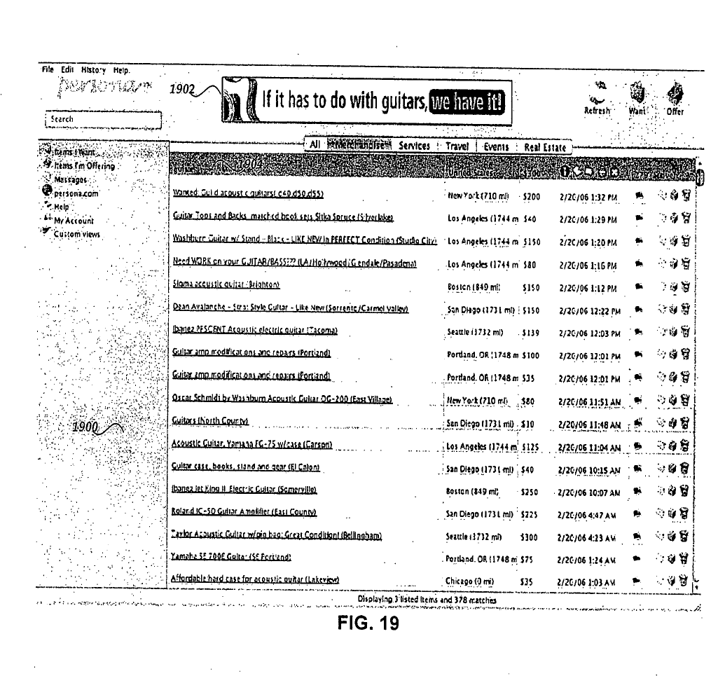

FIG. 19 is an example of one embodiment of a buyer application 1900 displaying a banner advertisement 1902 associated with a keyword 1904. If the buyer becomes interested in an offer of sale advertised in the banner advertisement 1902, the buyer clicks on the banner advertisement 1902. In response to the buyer clicking on the banner advertisement 1902, the buyer application sends a request for the web-based media advertisement associated with the banner advertisement 1902 to the location at the RSS feed provider received from the RSS feed provider.

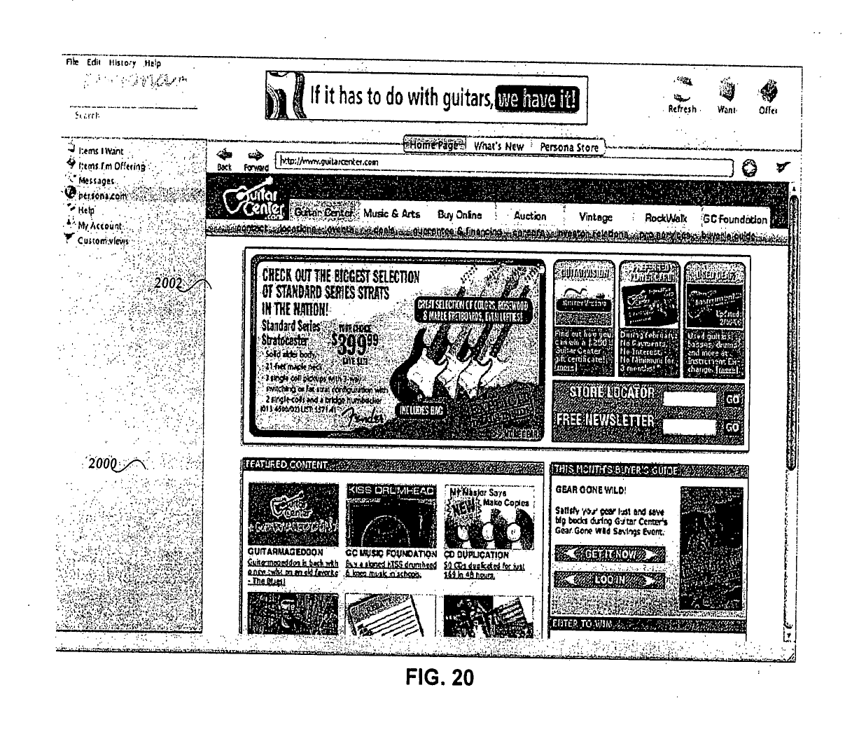

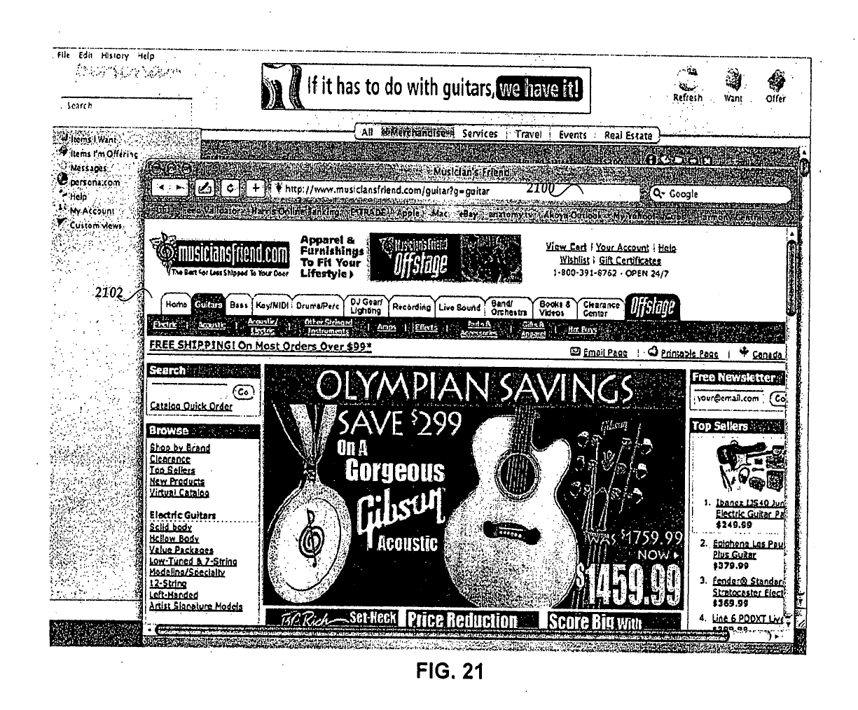

Upon receiving the request, the RSS feed provider sends the web-based media associated with the banner advertisement 1902 to the buyer device, and in one embodiment, the buyer application launches the web-based media advertisement within the buyer application. FIG. 20 is an example of one embodiment of a buyer application 2000 displaying a web-based media advertisement 2002 within the buyer application 2000. In another embodiment, another application running on the buyer device, such as an Internet browser, launches the web-based media advertisement. FIG. 21 is an example of one embodiment of an Internet browser 2100 displaying a web-based media advertisement 2102. After the buyer application or other application launches the web-based media advertisement, the buyer may interact with the web-based media to complete or abandon the transaction.

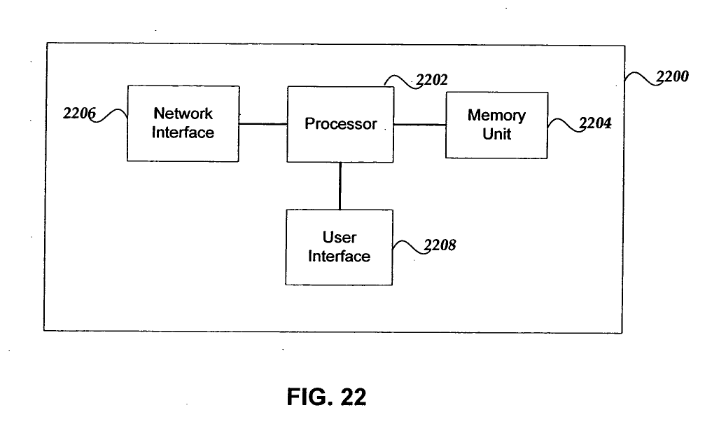

FIG. 22 is a block diagram of one embodiment of a seller device for advertising offers of sale over a decentralized network. Generally, the seller device 2200 comprises a processor 2202, a memory 2204 in communication with the processor 2202, a network interface 2206 in communication with the processor 2202, and a user interface 2208 in communication with the processor 2202. During operation, the processor 2202 executes instructions stored in memory to receive commands from a seller via the user interface 2208 for creating an advertisement and to create the advertisement based on the received commands.

After creating the advertisement, the processor 2202 executes additional instructions stored in memory 2204 to communicate with a RSS feed provider via the network interface 2206 to reserve one or more keywords and to send a banner advertisement and a web-based media advertisement related to the keywords to the RSS feed provider.

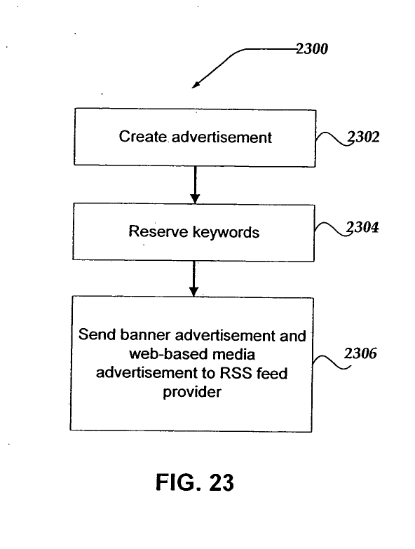

FIG. 23 is a flow chart of one embodiment of a method for advertising offers of sale over a decentralized network. The method 2300 begins with a seller creating a banner advertisement 2302. The seller uses a stand-alone seller application running on a seller device, or other forms of communication, to communicate with the RSS feed provider to reserve one or more keywords 2304 and send both the banner advertisement and a web-based media advertisement related to the reserved keywords to the RSS feed provider 2306.

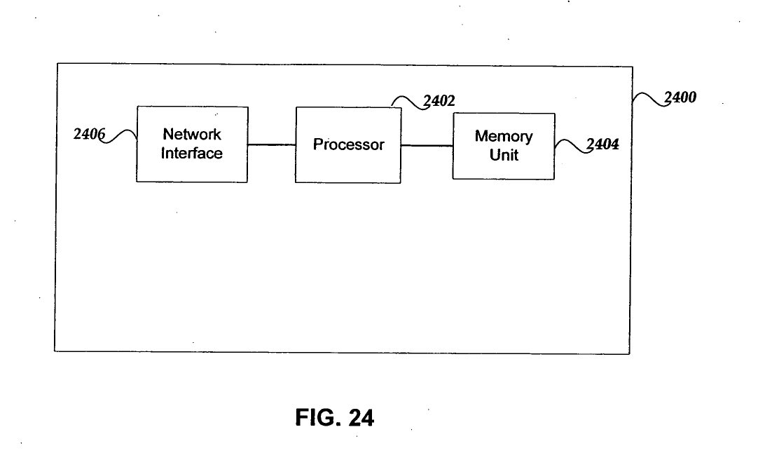

FIG. 24 is a block diagram of one embodiment of a RSS feed provider for disseminating advertisements over a decentralized network. Generally, the RSS feed provider 2400 comprises a processor 2402, a memory 2404 in communication with the processor 2402, and a network interface 2406 in communication with the processor 2402. During operation, the processor 2402 is operative to execute instructions stored in memory 2404 to receive a request to reserve one or more keywords via the network interface 2406 from a seller device, to reserve the one or more keywords, and to receive a banner advertisement and a web-based media advertisement related to the reserved keywords via the network interface 2406 from the seller device.

Once the banner advertisement and web-based media advertisement are received, the processor 2402 executes instructions stored in memory 2404 to create a RSS file based on the received advertisements. Periodically, the processor 2402 executes instructions stored in memory 2404 to create a RSS feed comprising the RSS file based on the received advertisements and to disseminate the RSS feed via the network interface 2406 to one or more potential buyers. Typically, the RSS feed comprises a location at the RSS feed provider to request the banner advertisement and not the actual banner advertisement itself.

After disseminating the RSS feed, the processor 2402 executes instructions stored in memory 2404 to receive a request via the network interface 2406 from a buyer device for the banner advertisement and to send the requested banner advertisement and a location at the RSS feed provider to request the web-based media advertisement to the buyer device via the network interface 2406. The processor 2402 executes instructions stored in memory 2404 to receive a request via the network interface 2406 from the buyer device for the web-based media advertisement associated with the banner advertisement and to serve the web-based media advertisement to the buyer device via the network interface 2406.

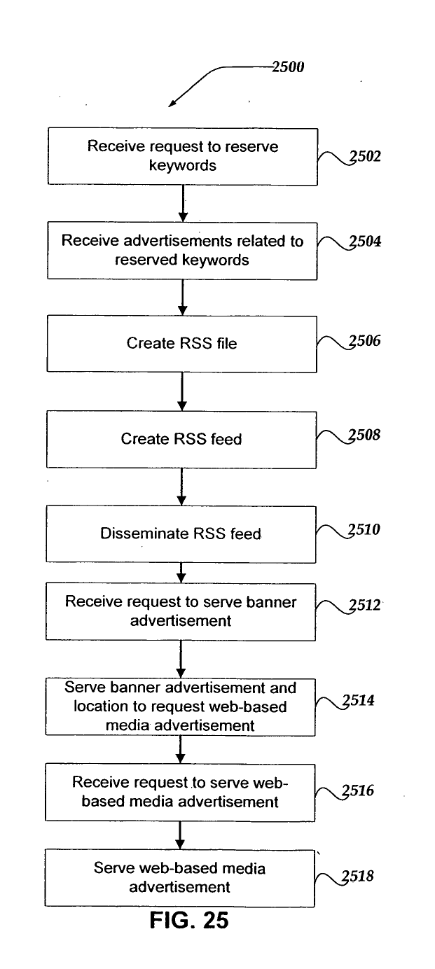

FIG. 25 is a flow chart of one embodiment of a method for disseminating advertisement over a decentralized network. The method 2500 begins with a RSS feed provider receiving a request from a seller device to reserve one or more keywords and the RSS feed provider reserving the keywords 2502. The RSS feed provider then receives a banner advertisement and a web-based media advertisement related to the reserved keywords 2504 and creates a RSS file based on the received advertisements 2506.

Periodically, the RSS feed provider creates a RSS feed comprising the RSS file based on the received advertisements 2508 and disseminates the RSS feed to one or more potential buyers 2510. The RSS feed may comprise a location to request the banner advertisement and not the banner advertisement itself. After disseminating the RSS feed, the RSS feed provider receives a request from at least one of the one or more potential buyers to serve the banner advertisement 2512 and serves the banner advertisement and location at the RSS feed provider to request the web-based media advertisement to the buyer device requesting the banner advertisement 2514. The RSS feed provider receives a request from the buyer device requesting the banner advertisement for the web-based media advertisement associated with the banner advertisement 2516 and serves the web-based media advertisement to the buyer device 2518.

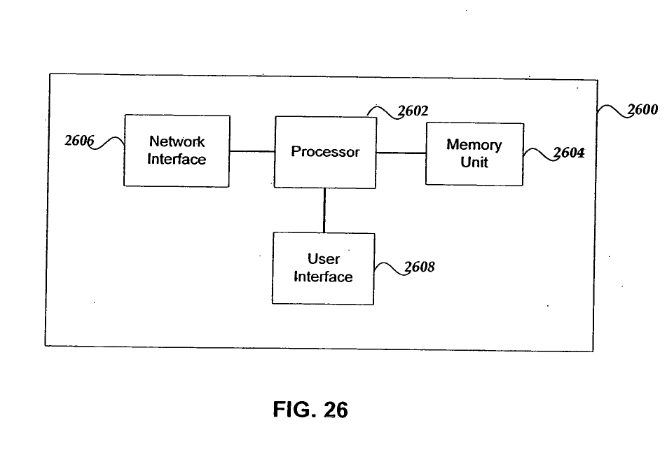

FIG. 26 is a block diagram of one embodiment of a buyer device for receiving offers of sale over a decentralized network. Generally, the buyer device 2600 comprises a processor 2602, a memory 2604 in communication with the processor 2602, a network interface 2606 in communication with the processor 2602, and a user interface 2608 in communication with the processor 2602. During operation, the processor 2602 executes instructions stored in memory 2604 to receive commands from a buyer via the user interface 2608 to save keywords in memory 2604.

The processor 2602 executes additional instructions stored in memory 2604 to receive a RSS feed from a RSS feed provider via the network interface 2606 and to parse the RSS feed into one or more offer listings and one more locations for banner advertisements. After parsing the RSS feed, the processor 2602 executes further instructions stored in memory 2604 to match a keyword associated with a location of a banner advertisement to the keywords stored in memory 2604 and to request the banner advertisement matching the keyword stored in memory 2604 from the RSS feed provider via the network interface 2606.

The processor 2602 executes instructions stored in memory 2604 to receive the banner advertisement and a location at the RSS feed provider for a web-based media advertisement associated with the banner advertisement from the RSS feed provider via the network interface 2606 and to display the received banner advertisement to the buyer via the user interface 2608. After displaying the banner advertisement, the processor 2602 executes further instructions stored in memory 2604 to request the web-based media advertisement via the network interface 2636 from the RSS feed provider based on actions of the buyer. The processor 2602 executes instructions stored in memory 2604 to receive the web-based media advertisement via the network interface 2606 and to display the web-based media advertisement via the user interface 2608 to the buyer. The processor executes further instructions stored in memory 2604 to interact with the web-based media advertisement via the network interface 2606 based on commands received from the buyer via the user interface 2608 and to complete or abandon the transaction based on the commands received from the buyer via the user interface 2608.

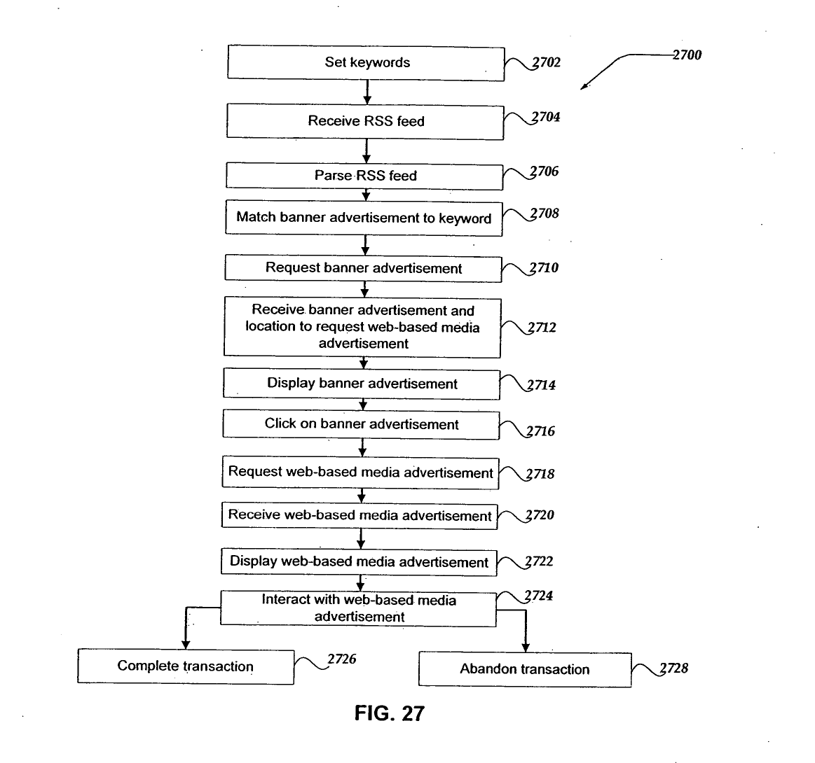

FIG. 27 is a flow chart of one embodiment of a method for receiving offers of sale over a decentralized network. Generally, the method 2700 begins with a buyer setting one or more keywords at a stand-alone buyer application 2702. The buyer device receives a RSS feed from a RSS feed provider 2704 and parses the RSS feed into one or more partial offer listings and one or more locations of banner advertisements 2706. The buyer application matches at least one of the one more locations of banner advertisements to the keywords stored at the buyer application 2708 and requests the matched banner advertisement from the RSS service provider 2710.

The buyer application receives the requested banner advertisement and a location at the RSS feed provider for a web-based media advertisement associated with the banner advertisement 2712 and displays the banner advertisement to the buyer 2714. After viewing the banner advertisement, the buyer may click on the banner advertisement 2716, causing the buyer application to send a request to the RSS feed provider for the web-based media advertisement associated with the banner advertisement 2718. The buyer application receives the web-based media advertisement 2720 and displays the web-based media advertisement 2722 to the buyer. The buyer uses the buyer application to interact with the web-based media advertisement 2724 and to complete 2726 or abandon the transaction 2728.

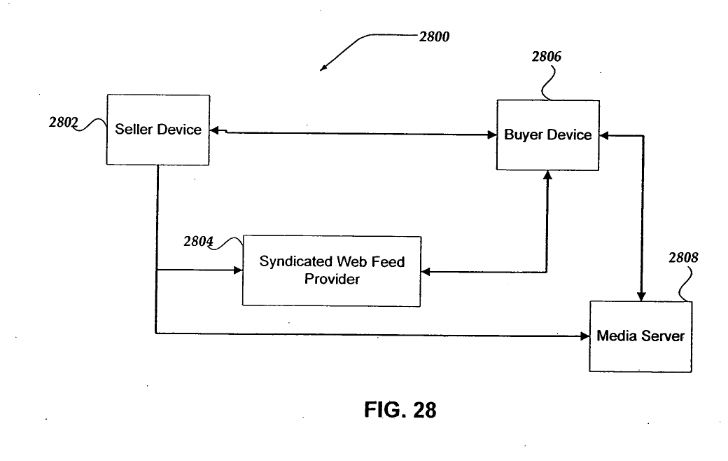

FIG. 28 is a block diagram of another embodiment of a system for advertising products and services over a decentralized network. In contrast to the system described with respect to FIGS. 18-27, in the embodiment described in detail below, the seller application only sends a location of a web-based media advertisement to a RSS feed provider, and a buyer application requests the web-based media advertisement from a media server other than the RSS feed provider.

The system comprises a user device 2802, a syndicated web feed provider 2804 such as a RSS feed provider, a buyer device 2806, and a media server 2808. To advertise products and services over a decentralized network, a seller uses a stand-alone seller application running on a seller device 2802, ot another form of communication, to reserves keywords with the RSS feed provider 2804 and to send both a banner advertisement and a location of a web-based media advertisement that is stored on the media server 2808 to the RSS feed provider 2804.

The RSS feed provider 2804 receives the reserved keywords, banner advertisement, and location of the web-based media advertisement associated with the reserved keywords that is stored on the media server 2808, and creates a RSS file based on the received keywords, banner advertisement, and location of the web-based media advertisement associated with the reserved keywords. Periodically, the RSS feed provider 2804 creates a RSS feed comprising the RSS file. In one embodiment, the RSS feed may be the same RSS feed described above with respect to FIGS. 1-17 comprising partial offer listings.

The buyer device 2806 receives the RSS feed from the RSS feed provider 2804 and a stand-alone buyer application parses the RSS feed into one or more partial offer listings that the buyer may be interested in and one or more locations of banner advertisements related to products and services that the buyer may be interested in. When a buyer performs actions in the buyer application such as clicking to see offer listings related to a keyword, the buyer application automatically requests a banner advertisement from the RSS feed provider 2804. The banner advertisement and a location at the media server 2808 for the web-based media advertisement associated with the banner advertisement are sent from the RSS feed provider 2804 to the buyer device 2806 and the buyer application displays the received banner advertisement to the buyer.

If the buyer becomes interested in an offer of sale advertised in the banner advertisement, the buyer clicks on the banner advertisement. In response to the buyer clicking on the banner advertisement, the buyer application sends a request for the web-based media advertisement associated with the banner advertisement to the location at the media server 2808 received from the RSS feed provider 2804.

The media server 2808 sends the web-based media advertisement associated with the banner advertisement to the buyer device 2806, and in one embodiment, the buyer application launches the web-based media advertisement within the buyer application. In another embodiment, another application running on the buyer device 2806, such as an Internet browser, launches the web-based media advertisement. After the buyer application or other application launches the web-based media advertisement, the buyer may interact with the web-based media to complete or abandon the transaction.

It will be appreciated that any of the seller applications or buyer applications described above with respect to FIG. 1-28 may simply be different functions of a single user application. For example, a single stand-alone user application may be used to create offer listings and create advertisements from the perspective of a seller, or view partial offer listings and advertisements from the perspective of a buyer. Further, it will be appreciated that a single RSS feed provider may create a RSS feed that comprises any combination of partial offer listings and locations of banner advertisements having web-based media advertisement associated with the banner advertisements that are stored at the RSS feed provider or at a media server.

Further, in other embodiments of the systems and methods described above with respect to FIG. 1-28, the system could be modified such that a seller may choose to store information related to offer listings at the RSS feed provider. For example, after the seller creates an offer listing, instead of extracting a set of information to send to the service provider, the seller may send the entire offer listing to the RSS feed provider for storage.

One skilled in the art will recognize that the system disclosed above provides many advantages. For example, the disclosed system provides sellers with enhanced advertisement targeting, and buyers with enhanced advertisement relevancy, due to the fact the buyer application displays advertisements based on keywords which embody products and services the buyer has expressed an interest in purchasing.

Further, the disclosed system provides enhanced privacy to buyers due to the fact the buyer application does not transmit keywords entered by a buyer over the internet; the information about the buyer's “searches” remains private and locally stored. The peer-to-peer communications between the seller and buyer of the disclosed system additionally provide enhanced privacy. The peer-to-peer communications are not routed through another entity such as the syndicated web feed provider that could record the communications or mine the communications for information related to products or services the potential buyer is interested in purchasing.

The disclosed system additionally provides controls to click fraud due to the fact the buyer application requests banner ads and web-based media advertisements based on predefined links that are typically not known to a buyer, rather than a buyer clicking on a link on a web page. Thus, requests for banner ads and web-based media advertisements are limited to actuation of a specific process such as a match of a keyword saved at the buyer application with a keyword in the web feed. Further, it will be appreciated that the web feed provider or the buyer application could implement various algorithms to control click fraud such as programming the buyer application to prevent it from requesting the same banner advertisement or web-based media advertisement multiple times.

In the disclosed system, a user is not limited to listing items that are of immediate availability for purchase or sale; the user may also create offer listings, banner advertisements, web-based media advertisements, or keywords relating to general areas of interest that reflect long-term hobbies, favorites, or needs such as dining, sports teams, or medical conditions. In this way, the disclosed system can be used for matching advertisers with potential future customers, as well as for matching users with other users that share the same interests. Further, the disclosed system provides the ability for advertisers and sellers to target a plurality of keywords on a system of a potential buyer, all of which are of current or long-term interest to the buyer.

In the disclosed system, the use of a locally installed application for buyers and sellers that is not part of an internet browser additionally provides a series of user-interface enhancements such as simplified listing of items for sale, maintenance of an ads-viewed history, and enhanced item management.

It is therefore intended that the foregoing detailed description be regarded as illustrative rather than limiting, and that it be understood that it is the following claims, including all equivalents, that are intended to define the spirit and scope of this invention.

1. A method for distributing advertisements to a plurality of potential buyers, comprising:
receiving a request to reserve one or more keywords from a seller;
receiving a banner advertisement and a web-based media advertisement related to the one or more reserved keywords from the seller, the banner advertisement and web-based media advertisement associated with an offer of sale;
creating an extensible markup language (“XML”) file based on the one or more keywords, banner advertisement, and web-based media advertisement;
creating a web feed comprising the XML file; and
disseminating the web feed to a plurality of stand-alone buyer applications.

2. The method of claim 1, wherein the XML file is a Rich Site Summary (RSS 0.91) file.

3. The method of claim 1, wherein the XML file is a RDF Site Summary (RSS 0.9 and 1.0) file.

4. The method of claim 1, wherein the XML file is a Really Simple Syndication (RSS 2.0) file.

5. The method of claim 1, wherein the offer of sale is an offer to sell a product.

6. The method of claim 1, wherein the offer of sale is an offer to sell a service.

7. The method of claim 1, wherein the offer of sale comprises information relating to a general area of interest.

8. The method of claim 1, wherein the web-based media advertisement is a video clip.

9. The method of claim 1, wherein the web-based media advertisement is an Internet address.

10. The method of claim 1, further comprising:
receiving a request for the banner advertisement from at least one of the plurality of stand-alone buyer applications; and
sending the banner advertisement and a location to request the web-based media advertisement to the at least one of the plurality of stand-alone buyer applications.

11. The method of claim 10, further comprising:
receiving a request for the web-based media advertisement from at least one of the plurality of stand-alone buyer applications; and
sending the web-based media advertisement to the at least one of the plurality of stand-alone buyer applications that requested the stand-alone buyer application.

12. A method for distributing advertisements to a plurality of potential buyers, comprising:
receiving a request to reserve one or more keywords from a seller;
receiving a banner advertisement and a location to request a web-based media advertisement related to the one or more reserved keywords from the seller, the banner advertisement and web-based media advertisement associated with an offer of sale;
creating an extensible markup language (“XML”) file based on the one or more keywords, banner advertisement, and location to request the web-based media advertisement;
creating a web feed comprising the XML file; and
disseminating the web feed to a plurality of stand-alone buyer applications.

13. The method of claim 12, wherein the XML file is a Rich Site Summary (RSS 0.91) file.

14. The method of claim 12, wherein the XML file is a RDF Site Summary (RSS 0.9 and 1.0) file.

15. The method of claim 12, wherein the XML file is a Really Simple Syndication (RSS 2.0) file.

16. The method of claim 12, wherein the offer of sale is an offer to sell a product.

17. The method of claim 12, wherein the offer of sale is an offer to sell a service.

18. The method of claim 12, wherein the offer of sale comprises information relating to a general area of interest.

19. The method of claim 12, wherein the web-based media advertisement is a video clip.

20. The method of claim 12, wherein the web-based media advertisement is an Internet address.

21. The method of claim 12, further comprising:
receiving a request for the banner advertisement from at least one of the plurality of stand-alone buyer applications; and
sending the banner advertisement and the location to request the web-based media advertisement to the at least one of the plurality of stand-alone buyer applications.

22. The method of claim 21, further comprising:
receiving a request for the web-based media advertisement from at least one of the plurality of stand-alone buyer applications; and
sending the web-based media advertisement to the at least one of the plurality of stand-alone buyer applications that requested the stand-alone buyer application.

23. A computer-readable storage medium comprising a set of instructions for distributing advertisements to a plurality of potential buyers, the set of instructions to direct a computer system to perform acts of:
receiving a request to reserve one or more keywords from a stand-alone seller application;
receiving a banner advertisement and a web-based media advertisement related to the one or more reserved keywords from the stand-alone seller application, the banner advertisement and web-based media advertisement associated with an offer of sale;
creating an extensible markup language (“XML”) file based on the one or more keywords, banner advertisement, and web-based media advertisement;
creating a web feed comprising the XML file; and
disseminating the web feed to a plurality of stand-alone buyer applications.

24. The computer-readable storage medium of claim 23, wherein the XML file is a Rich Site Summary (RSS 0.91) file.

25. The computer-readable storage medium of claim 23, wherein the XML file is a RDF Site Summary (RSS 0.9 and 1.0) file.

26. The computer-readable storage medium of claim 23, wherein the XML file is a Really Simple Syndication (RSS 2.0) file.

27. The computer-readable storage medium of claim 23, wherein the web-based media advertisement is a video clip.

28. The computer-readable storage medium of claim 23, wherein the web-based media advertisement is an Internet address.

29. The computer-readable storage medium of claim 26, further comprising a set of instructions to direct the computer system to perform acts of:
receiving a request for the banner advertisement from at least one of the plurality of stand-alone buyer applications; and
sending the banner advertisement and a location to request the web-based media advertisement to the at least one of the plurality of stand-alone buyer applications.

30. The computer-readable storage medium of claim 29, further comprising a set of instructions to direct the computer system to perform acts of:
receiving a request for the web-based media advertisement from at least one of the plurality of stand-alone buyer applications; and
sending the web-based media advertisement to the at least one of the plurality of stand-alone buyer applications that requested the stand-alone buyer application.

31. A computer-readable storage medium comprising a set of instructions for distributing advertisements to a plurality of potential buyers, the set of instructions to direct a computer system to perform acts of:
receiving a request to reserve one or more keywords from a stand-alone seller application;
receiving a banner advertisement and a location to request a web-based media advertisement related to the one or more reserved keywords from the stand-alone seller application, the banner advertisement and web-based media advertisement associated with an offer of sale;
creating an extensible markup language (“XML”) file based on the one or more keywords, banner advertisement, and the location to request the web-based media advertisement;
creating a web feed comprising the XML file; and
disseminating the web feed to a plurality of stand-alone buyer applications.

32. The computer-readable storage medium of claim 31, wherein the XML file is a Rich Site Summary (RSS 0.91) file.

33. The computer-readable storage medium of claim 31, wherein the XML file is a RDF Site Summary (RSS 0.9 and 1.0) file.

34. The computer-readable storage medium of claim 31, wherein the XML file is a Really Simple Syndication (RSS 2.0) file.

35. The computer-readable storage medium of claim 31, wherein the web-based media advertisement is a video clip.

36. The computer-readable storage medium of claim 31, wherein the web-based media advertisement is an Internet address.

37. The computer-readable storage medium of claim 36, further comprising a set of instructions to direct the computer system to perform acts of:
receiving a request for the banner advertisement from at least one of the plurality of stand-alone buyer applications; and
sending the banner advertisement and the location to request the web-based media advertisement to the at least one of the plurality of stand-alone buyer applications.

38. A server for distributing advertisements to a plurality of potential buyers, comprising:
a memory operative to store a plurality of instructions;
a processor in communication with the memory; and
a network interface in communication with the processor and the decentralized network;
wherein the processor is operative to receive and execute instructions stored in memory to receive a request via the network interface from a stand-alone seller application to reserve one or more keywords, to receive a banner advertisement and a web-based media advertisement related to the reserved one or more keywords via the network interface from the stand-alone seller application, to create an extensible markup language (“XML”) file based on the one or more keywords, banner advertisement, and web-based media advertisement, to create a web feed comprising the XML file, and to disseminate the web feed to a plurality of stand-alone buyer applications.

39. The server of claim 38, wherein the XML file is a Rich Site Summary (RSS 0.91) file.

40. The server of claim 38, wherein the XML file is a RDF Site Summary (RSS 0.9 and 1.0) file.

41. The server of claim 38, wherein the XML file is a Really Simple Syndication (RSS 2.0) file.

42. The server of claim 38, wherein the processor is further operative to receive and execute instructions stored in memory to receive a request from at least one of the plurality of stand-alone buyer applications via the network interface for the banner advertisement and to send the banner advertisement and a location to request the web-based media advertisement to the at least one of the plurality of stand-alone buyer applications via the network interface.

43. The server of claim 42, wherein the processor is further operative to receive and execute instructions stored in memory to receive a request from at least one of the plurality of stand-alone buyer applications via the network interface for the web-based media advertisement and to send the web-based media advertisement to the at least one of the plurality of stand-alone buyer applications via the network interface.

44. A server for distributing advertisements to a plurality of potential buyers, comprising:
a memory operative to store a plurality of instructions;
a processor in communication with the memory; and
a network interface in communication with the processor and the decentralized network;
wherein the processor is operative to receive and execute instructions stored in memory to receive a request via the network interface from a stand-alone seller application to reserve one or more keywords, to receive a banner advertisement and a location to request a web-based media advertisement related to the reserved one or more keywords via the network interface from the stand-alone seller application, to create an extensible markup language (“XML”) file based on the one or more keywords, banner advertisement, and location to request the web-based media advertisement, to create a web feed comprising the XML file, and to disseminate the web feed to a plurality of stand-alone buyer applications.

45. The server of claim 44, wherein the XML file is a Rich Site Summary (RSS 0.91) file.

46. The server of claim 44, wherein the XML file is a RDF Site Summary (RSS 0.9 and 1.0) file.

47. The server of claim 44, wherein the XML file is a Really Simple Syndication (RSS 2.0) file.

48. The server of claim 44, wherein the processor is further operative to receive and execute instructions stored in memory to receive a request from at least one of the plurality of stand-alone buyer applications via the network interface for the banner advertisement and to send the banner advertisement and the location to request the web-based media advertisement to the at least one of the plurality of stand-alone buyer applications via the network interface.

49. A method for receiving offers of sale over a decentralized network, comprising:
receiving a web feed at a stand-alone application residing on a personal device of a user, the web feed comprising one or more locations to request a banner advertisement regarding an offer of sale.
parsing the web feed into one or more locations to request a banner advertisement;
matching a keyword associated with a location to request a banner advertisement to a keyword saved on the stand-alone application;
sending a request to a location to request a banner advertisement associated with the keyword that matches the keyword saved on the stand-alone application;
receiving the banner advertisement and a location to request a web-based media advertisement associated with the banner advertisement; and
displaying the banner advertisement to a user.

50. The method of claim 49, wherein the web feed comprises a plurality of extensible markup language (“XML”) files, at least one of the XML files in a Rich Site Summary (RSS 0.91) format.

51. The method of claim 49, wherein the web feed comprises a plurality of XML files, at least one of the XML files in a RDF Site Summary (RSS 0.9 and 1.0) format.

52. The method of claim 49, wherein the web feed comprises a plurality of XML files, at least one of the XML files in a Really Simple Syndication (RSS 2.0) format.

53. The method of claim 49, wherein the offer of sale is an offer to sell a product.

54. The method of claim 49, wherein the offer of sale is an offer to sell a service.

55. The method of claim 49, wherein the offer of sale comprises information relating to a general area of interest.

56. The method of claim 49, wherein the web-based media advertisement is a video clip.

57. The method of claim 49, wherein the web-based media advertisement is an Internet address.

58. The method of claim 49, further comprising:
receiving an indication from the user that the user is interested in the banner advertisement;
sending a request for the web-based media advertisement associated with the banner advertisement;
receiving the requested web-based media advertisement; and
displaying the web-based media advertisement to the user.

59. The method of claim 58, wherein the request for the web-based media advertisement associated with the banner advertisement is sent to a syndicated web feed provider.

60. The method of claim 58, wherein the request for the web-based media advertisement associated with the banner advertisement is sent to a media server.

61. The method of claim 58, wherein the web-based media advertisement is displayed to the user within the stand-alone application.

62. The method of claim 58, wherein the web-based media advertisement is displayed to the user in an Internet browser running on the personal device of the user.

63. The method of claim 58, further comprising:
interacting with the web-based media advertisement based on commands received from the user;
completing a transaction for the offer of sale.

64. A computer-readable storage medium comprising a set of instructions for receiving advertisements over a decentralized network, the set of instructions to direct a computer system to perform the acts of:
receiving a web feed at a stand-alone application residing on a personal device of a user, the web feed comprising one or more locations to request a banner advertisement regarding an offer of sale.
parsing the web feed into one or more locations to request a banner advertisement;
matching a keyword associated with a location to request a banner advertisement to a keyword saved on the stand-alone application;
sending a request to a location to request a banner advertisement associated with the keyword that matches the keyword saved on the stand-alone application;
receiving the banner advertisement and a location to request a web-based media advertisement associated with the banner advertisement; and
displaying the banner advertisement to a user.

65. The computer-readable storage medium of claim 64, wherein the web feed comprises a plurality of extensible markup language (“XML”) files, at least one of the XML files in a Rich Site Summary (RSS 0.91) format.

66. The computer-readable storage medium of claim 64, wherein the web feed comprises a plurality of XML files, at least one of the XML files in a RDF Site Summary (RSS 0.9 and 1.0) format.

67. The computer-readable storage medium of claim 64, wherein the web feed comprises a plurality of XML files, at least one of the XML files in a Really Simple Syndication (RSS 2.0) format.

68. The computer-readable storage medium of claim 64, wherein the web-based media advertisement is a video clip.

69. The computer-readable storage medium of claim 64, wherein the web-based media advertisement is an Internet address.

70. The computer-readable storage medium of claim 64, further comprising a set of instructions to direct the computer system to perform the acts of:
receiving an indication from the user that the user is interested in the banner advertisement;
sending a request for the web-based media advertisement associated with the banner advertisement;
receiving the requested web-based media advertisement; and
displaying the web-based media advertisement to the user.

71. The computer-readable storage medium of claim 70, wherein the request for the web-based media advertisement associated with the banner advertisement is sent to a syndicated web feed provider.

72. The computer-readable storage medium of claim 70, wherein the request for the web-based media advertisement associated with the banner advertisement is sent to a media server.

73. The computer-readable storage medium of claim 70, further comprising a set of instructions to direct the computer system to perform acts of:
interacting with the web-based media advertisement based on commands received from the user;
completing a transaction for the offer of sale.

74. A computer system configured for receiving advertisements over a decentralized network, comprising:
a user interface;
a memory operative to store a plurality of instructions;
a processor in communication with the memory and the user interface; and
a network interface in communication with the processor and the decentralized network;
wherein the processor is operative to execute instructions stored in memory to receive a web feed via the network interface comprising one or more locations to request a banner advertisement regarding an offer of sale, to parse the web feed into one or more locations to request a banner advertisement, to match a keyword associated with a location to request a banner advertisement to a keyword saved in memory, to send a request via the network interface for the banner advertisement associated with the keyword that matches the keyword saved in memory, to receive the banner advertisement and a location to request a web-based media advertisement associated with the banner advertisement via the network interface, and to display the advertisement to the user via the user interface.

75. The computer system of claim 74, wherein the web feed comprises a plurality of extensible markup language (“XML”) files, at least one of the XML files in a Rich Site Summary (RSS 0.91) format.

76. The computer system of claim 74, wherein the web feed comprises a plurality of XML files, at least one of the XML files in a RDF Site Summary (RSS 0.9 and 1.0) format.

77. The computer system of claim 74, wherein the web feed comprises a plurality of XML files, at least one of the XML files in a Really Simple Syndication (RSS 2.0) format.

78. The computer system of claim 74, wherein the processor is further operative to execute instructions stored in memory to receive an indication from the user that the user is interested in the banner advertisement via the user interface, to send a request for the web-based media advertisement via the network interface, to receive the web-based media advertisement via the network interface, and to display the web-based media advertisement to the user via the user interface.

79. The computer system of claim 78, wherein the processor is further operative to execute instructions stored in memory to interact with the web-based media advertisement via the network interface based on commands received from the user via the user interface and to complete a transaction based on the interaction with the web-based media advertisement.
